(19) United States
(12) Patent Application Publication
(10) Pub. No.: US 2007/0078618 A1
(43) Pub. Date: Apr. 5, 2007

(54) Method and system for enabling automated data analysis of multiple commensurate nondestructive test measurements

(75) Inventors: David E. Wilcox, Gilbert, AZ (US); Paul Michael Jones, Glendale, AZ (US); Grant A. Gordon, Peoria, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/239,885

(22) Filed: Sep. 30, 2005

(51) Int. Cl. G06F 19/00

(52) U.S. Cl. 702/113

(57) ABSTRACT

A method for analyzing test data from nondestructive evaluation of an aircraft includes generating a model of the aircraft with an inspection point. The aircraft is mapped to the model of the aircraft. Then, measurement data is generated by nondestructive testing an area of the aircraft corresponding to the inspection point. The measurement data is stored with associated location data of the inspection point and measurement parameters for comparison. The model of the aircraft with the inspection point is displayed. The measurement test data is displayed for a selected inspection position.

### TECHNICAL FIELD OF THE INVENTION

This invention relates to the field of nondestructive testing and more specifically, to a method and system for enabling automated data analysis of multiple commensurate nondestructive test measurements.

### BACKGROUND OF THE INVENTION

Nondestructive testing and evaluation is a vital tool in investigating the integrity and reliability of a test structure. For example, nondestructive testing of an aircraft can be used to evaluate the integrity of different parts of the aircraft. More specifically, nondestructive testing can be used to detect cracks, surface discontinuities, structure variations and other types of material flaws.

By comparing current nondestructive test data against previous test data, changes in the state of a structure can be deduced. Thus, nondestructive testing data can be used to understand and manage the health-state of a structure through defect trending and remaining lifetime estimation. Typically, however, gathering test data over multiple tests and/or from multiple test structures and evaluating that data is difficult to achieve in an automated manner. Thus, this type of analysis is either not done or is done manually and generally suffers from the subjective bias common to manual analyses.

Data trending and other inferential data analysis applications depend on multiple nondestructive test data sets collected from essentially the same location on the test structure. On complex larger structures, such as the outer surface of the fuselage of an aircraft, there may be a need to collect many test data sets in order to inspect large areas. Once test data is collected for a complex structure at different locations, such as multiple locations on the aircraft fuselage, the test data should be stored so that the data from different locations can be easily retrieved. The test data can then be used for comparison with past or future measurements at the same location of the same test structure or the same location on a different test structure of the same type or model. Small variations in the shape of the structure or form of the structure e.g. local repair patch, which occur between data collection events or between aircrafts, may not influence the structure's integrity; however such variations can make it difficult to compare nondestructive measurements based strictly on location.

In view of the foregoing, it is desirable to provide a method for trending data from nondestructive testing that addresses one or more of the foregoing deficiencies or other deficiencies not implicitly or expressly described. It is also desirable to provide an apparatus for nondestructive testing that addresses one or more of the foregoing deficiencies or other deficiencies not implicitly or expressly described. Furthermore, other desirable factors and characteristics of the present invention will become apparent from the subsequent detailed description and the appended claims, taken in conjunction with the accompanying drawings and the foregoing technical field and background.

### SUMMARY OF THE INVENTION

A method for analyzing test data from nondestructive evaluation of an aircraft includes generating a model of the aircraft with an inspection point. The aircraft is mapped to the model of the aircraft to form a test model. Then, measurement data is generated by nondestructive testing an area of the aircraft corresponding to the inspection point. The measurement data is stored with associated location data of the inspection point, chronological data, and measurement parameters for comparison. The test model with the inspection point is displayed. The measurement test data is displayed for a selected inspection point.

In another embodiment, an apparatus for analyzing nondestructive testing data comprises a processor. The processor is configured to map an aircraft to a model of the aircraft, determine an inspection point for the model of the aircraft; and receive test data generated by performing nondestructive testing of the aircraft at the inspection point. Further, the apparatus includes a storage device coupled to the processor. The storage device is configured to store the test data with a location indication of where the nondestructive testing was performed along with chronological data. The apparatus further comprises a display device coupled to the processor and configured to display the model of the aircraft and the inspection point and display test data upon the selection of the inspection point of the model.

A system for performing nondestructive testing and viewing data generated from the nondestructive testing comprises a nondestructive testing device used to perform nondestructive evaluations of a test subject. The system further comprises a server computer coupled to the nondestructive testing device. The server computer is operable to map the test subject to a model of the test subject, determine one or more inspection points for the test subject based on the model of the test subject; and receive test data and test parameters generated by the nondestructive testing device performing nondestructive testing of the test subject at the one or more inspection points. The system also comprises a storage device coupled to the server. The storage device is operable to store the test data and test parameters with a location on the test subject where the nondestructive testing was performed, as well as chronological data.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures:

FIG. 1 is a partial view of an aircraft to be inspected and a nondestructive testing device in accordance with an exemplary embodiment of the present invention;

FIG. 2 is a flowchart of a method of collecting and storing test data in accordance with an exemplary embodiment of the present invention;

FIG. 3 illustrates a model of an aircraft and an aircraft that can be mapped together to produce a test model in accordance with an exemplary embodiment of the present invention;

FIG. 4 illustrates a positioning system to help in mapping the aircraft model and the actual aircraft in accordance with an exemplary embodiment of the present invention;

FIG. 5 illustrates a system for the evaluation of test data in accordance with an exemplary embodiment of the present invention; and

FIG. 6 illustrates an exemplary display for use in evaluating test data in accordance with an exemplary embodiment of the present invention.

### DETAILED DESCRIPTION OF THE DRAWINGS

The following detailed description is merely illustrative in nature and is not intended to limit the invention or the application and uses of the invention. Furthermore, there is no intention to be bound by any expressed or implied theory presented in the preceding technical field, background, brief summary or the following detailed description.

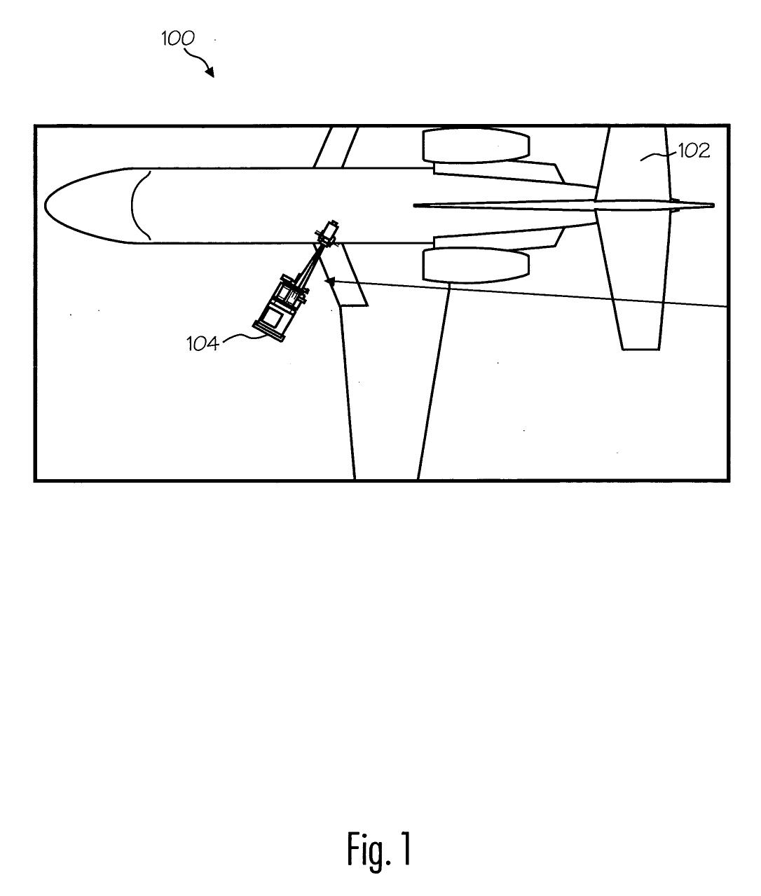

In one exemplary embodiment, the present invention can be used in an aviation embodiment. For example, in FIG. 1 an avionics testing system 100 is illustrated. Avionic testing system 100 can include an aircraft 102 and a nondestructive evaluation tester 104. The nondestructive evaluation tester 104 is operable to generate measurement data representative of the structural integrity of the aircraft 102 using one or more nondestructive testing methods. In one embodiment, nondestructive evaluation tester 104 utilizes an ultrasonic inspection tool to perform nondestructive testing on the surface of the aircraft 102. Moreover, because large test structures, such as the aircraft 102, require multiple tests to be performed at different locations in order to cover large areas of the aircraft 102 under inspection, the nondestructive evaluation tester 104 is operable to move about the aircraft 102 to perform testing at different locations.

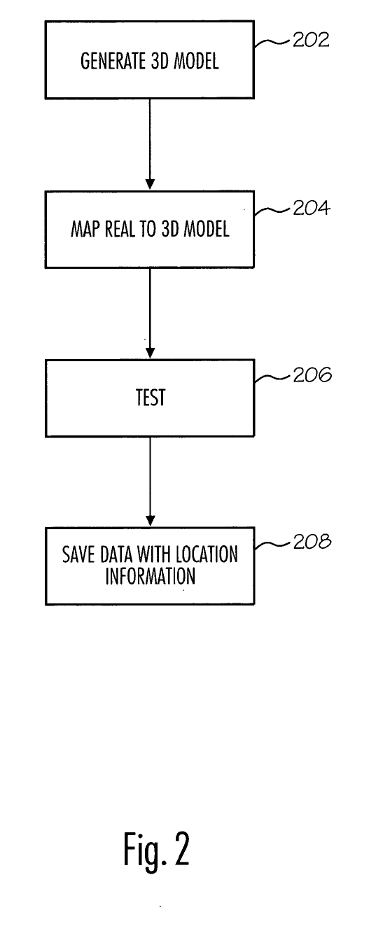

A flowchart 200 detailing a method for performing nondestructive testing is provided in FIG. 2. In a first step, step 202, an exemplary three dimensional model of the aircraft 102 is determined. In one embodiment, the three dimensional model of the aircraft can be generated from a solid object model rendering for the specific aircraft. Other methods of generating a model can also be used. The model of the aircraft can represent a canonical or ideal model. Individual aircraft can be compared to this model.

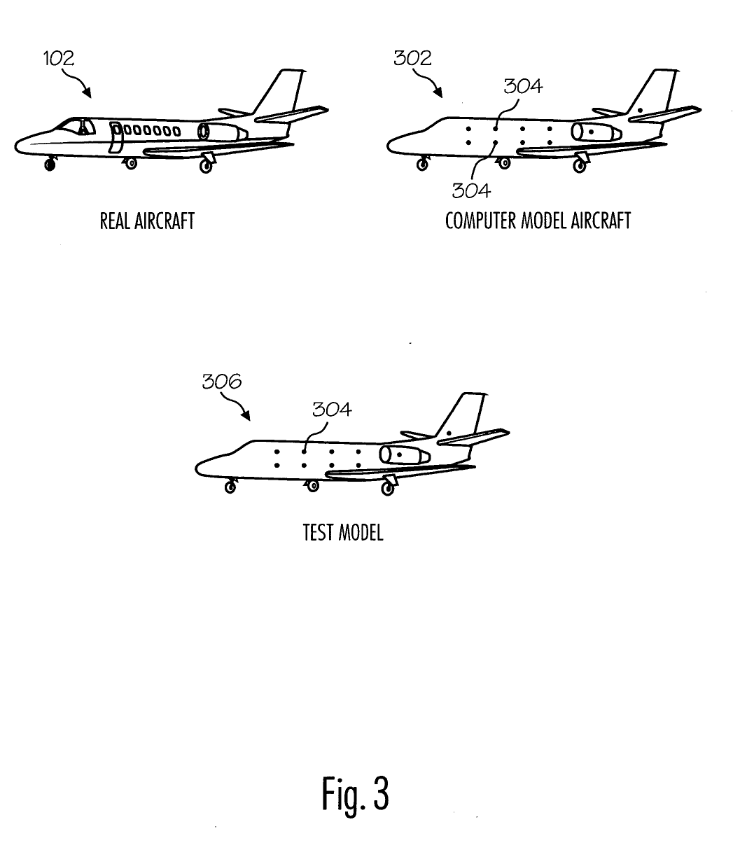

For example, an exemplary method of mapping an aircraft to a three dimensional model of the aircraft is illustrated. FIG. 3 illustrates a three dimensional aircraft model 302 which includes a plurality of inspection points 304 located on model 302. The inspection points 304 represent predetermined locations where nondestructive testing of the model 302 can take place. Model 302 can also be provided without predetermined inspection points 304. In such instances, nondestructive testing inspection points can be determined later and referenced to the model 302. In one exemplary embodiment, model 302 is a canonical aircraft model for a plurality of aircraft of similar design.

Once the model 302 is generated, the actual aircraft 102 is referenced to or mapped to the model 302 in step 204. Actual aircraft of that design can deviate from the canonical model due to factors such as manufacturing variations. By mapping the actual aircraft 102 to the model 302, testing can be conducted at the proper inspection points 304. Also, measurement data generated by the testing procedures can be stored with reference to locations on the test model 306, resulting in data sets that can be compared with data sets taken at later times for the same aircraft 102 or data sets generated from testing of other similar aircrafts.

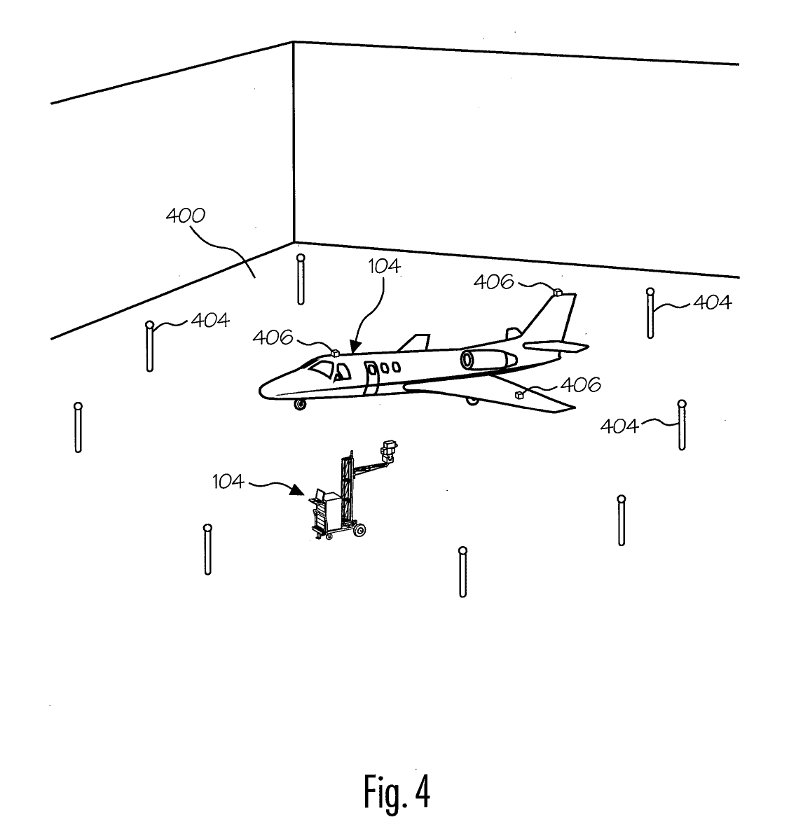

The aircraft 102 can be mapped onto the model 302 by various means. In one embodiment, the position of various locations of the aircraft 102 can be determined by the use of a localized positioning system. FIG. 4 illustrates an exemplary embodiment of a localized positioning system 400. Located in a hanger 401 or similar large structure is the aircraft 102. In one exemplary embodiment, at least two transmitters 404 are placed in fixed locations in the hanger 401, and a plurality of receivers 406 are placed on the aircraft 102. Transmitters 404, in an exemplary embodiment, transmit signals from which the receivers 406 can its azimuth (horizontal angle) and its elevation (vertical angle) relative to the transmitter 404. From the azimuth and elevation information, the receiver 406 can determine its position.

The positioning system can then be used to map the aircraft 102 to the model 302. In FIG. 4 the aircraft 102 has three receivers 406 installed at various places on its surface. The positions of the three receivers 406 are then determined as discussed above. After determining the location of the three receivers 406 in a coordinate system, the three locations can then be compared to the corresponding three points on the three dimensional model 302 of the aircraft. Using a best square fit routine along with any translations, rotations or morphological operations, local patches and data points of the aircraft 102 can be mapped onto the model 302. This represents one way of mapping the aircraft 102 onto the model 302. Other ways of mapping are also within the scope of the present invention.

In one exemplary embodiment, an airplane coordinate system of the model 302 can be associated with an airplane coordinate system of the aircraft 102 being tested. This can be accomplished by noting known positions on the aircraft 102 to the positions on the model 302. The model 302 can be used for all aircraft of a specific design. Because of fabrication differences, environmental operating differences and changes caused by maintenance, each aircraft of the same type can be different enough that the mappings are not identical; therefore, each aircraft of the same type in a fleet of aircraft can be individually mapped to the model using morphological operations or other mapping techniques.

Turning back to the method as illustrated in FIG. 2, in a next step, step 206, nondestructive testing is performed on the aircraft 102 using a nondestructive testing device such as the nondestructive evaluation tester 104. In one exemplary embodiment, the nondestructive test performed is an ultrasonic test, although other known appropriate nondestructive testing can be performed. The nondestructive test generates test data for each inspection point 304 or at any other location of interest.

Next, in step 208, the test data for each inspection point 304 is saved along with the location of the inspection points 304. For example, the test data for each inspection point 304 can be saved as {x, y, z, test data} where x, y, and z represent the location of the inspection points 304. In order to help determine data trends, the time and date that the test data was generated is also stored. The time and date the nondestructive test was performed can be used, for example, to adjust data taken at different dates to account for thermally induced structural changes due to the ambient temperature to which that the test subject is exposed during testing.

In addition, in one exemplary embodiment, any other information that might be needed for later analysis can be stored as metadata. Metadata can include the relationship between the model locations and the aircraft's datum and coordinate system, platform specific information, such as morphological operations required to map the specific aircraft form to the canonical aircraft model, nondestructive test measurement parameters, structure specific details such as the number of layers of material in the various locations, data processing and other measurement parameters the data collection location referenced by the model. The stored metadata can also be used to assist in locating the inspection points 304 on different aircraft. The location of any given inspection point 304 on one aircraft as compared to another may vary due to manufacturing differences and changes that occur during use. Metadata can be used to assist in adjusting the location of an inspection point 304 on an aircraft such that more accurate matches between different aircrafts can be obtained.

Thus, the record of each inspection point 304 can comprise: {x, y, z, date, test data, metadata}, where the metadata can comprise any other data that may be needed for evaluating purposes. Alternatively, the inspection points 304 can be numbered and associated with locations on the model 302. The test data and any other metadata can be stored with an inspection point 304 number.

After the test data is generated and stored, the test data can be retrieved and analyzed at a later time. In one exemplary embodiment, test data for an aircraft can be examined for a single test or for a series of tests. Additionally, test data for a number of aircraft can be aggregated and examined.

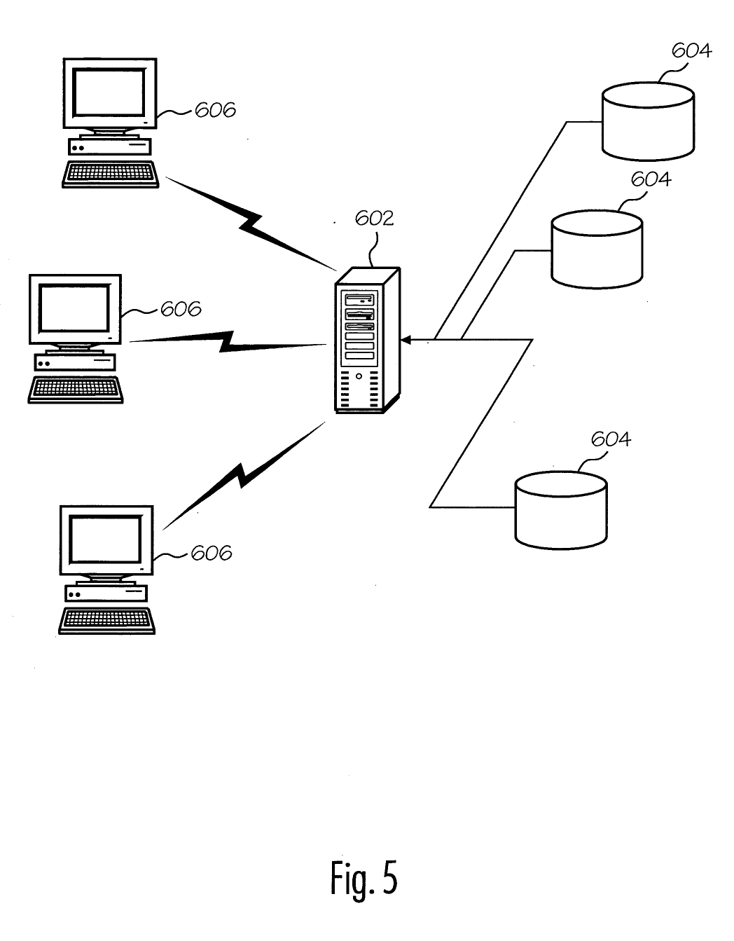

FIG. 5 illustrates an exemplary embodiment of a computer system 600 for use in the present invention. Computer system 600 can include a central server 602 coupled to one or more databases 604. Each database can contain test data for a specific type of aircraft. For example, database 604 can contain test data concerning all Boeing 737s in an airline fleet. Multiple remote computers 606 can communicate with server 602. Remote computers 606 can communicate with servers 602 in any of a number of ways, such as via a local area network, a wide area network, a connection through the Internet and the like. Such connections can be wired or wireless. Computer system 600, as shown in FIG. 5, is well known in the art and any computer system that allows data regarding one tested aircraft or multiple tested aircraft to be viewed and analyzed can be used in the present invention.

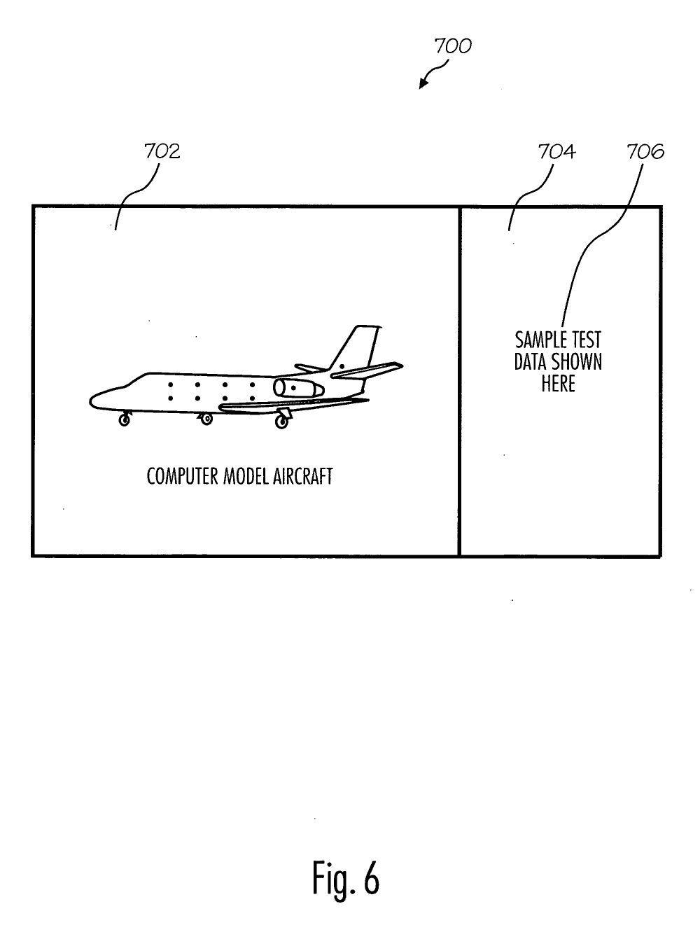

Operators of remote computers 606 can retrieve test data regarding a single aircraft or data relating to multiple aircrafts. FIG. 6 illustrates an exemplary computer display 700 that can be used by an operator of the remote computers 606. Computer display 700 includes an image section 702 and an information section 704. Image section 702, in one embodiment, shows test model 302 and the inspection points 304. An information section 704 includes data listings 706.

If the evaluation of individual aircraft is chosen, the result of one test or the results of more than one test for a single aircraft can be examined. If the results for one test are desired, the selection of one of the inspection points 304 in the display 700 can retrieve the current (or any other single test) test data results from the latest nondestructive test and display the test data in information section 704.

If the results from more than one test are desired, an inspection point 304 can be selected and test data from multiple nondestructive tests for the same aircraft can be displayed in the information section 704. The results can be shown as raw data, data that has been aggregated or data that has been preprocessed. In this manner trending and remaining lifetime estimation algorithms can be enabled based on the data from an individual aircraft.

The nondestructive testing results of more than one aircraft can also be displayed. If the testing results for multiple aircrafts are desired the results from a single test can be displayed or results for multiple tests can be displayed. If the results from one test are chosen, the latest (or any previous test) test results for all selected aircrafts can be viewed in display 700. This can be useful, for example, to determine if an abnormality in one aircraft occurs in other similar aircraft.

The test data for multiple aircrafts over a number of nondestructive tests can also be viewed. In this embodiment, the test data may undergo processing such that trends or patterns to the damage data can be more easily determined. The determination of trends in the test data over time and over different aircraft can be done in any of a number of ways. Examination of trends in the test data can be used to assist in the identification of structural anomalies.

The computer display 700 and the use of inspection point 304 on the model 302 to display test data is exemplary in nature and any system that allows test results to be viewed for individual aircrafts or multiple aircrafts can be used.

The exemplary embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed:

1. A method for analyzing test data from nondestructive evaluation of an aircraft comprising:
generating a model of the aircraft, the model including an inspection point;
mapping the aircraft to the generated model to form a test model;
nondestructive testing an area of the aircraft that corresponds to the inspection point, thereby generating measurement test data;
storing the measurement test data with location data representative of the inspection point and the test model;
displaying the stored test model with the inspection point; and
displaying measurement test data associated with the inspection point.

2. The method of claim 1 wherein the step of displaying measurement test data further comprises displaying measurement test data for multiple aircrafts related to the test model, the measurement test data generated from two or more inspections of multiple aircrafts.

3. The method of claim 1 wherein the step of displaying measurement test data further comprises displaying measurement test data for multiple aircrafts related to the test model, the measurement test data generated from a single nondestructive test.

4. The method of claim 1 wherein the step of displaying measurement test data further comprises displaying measurement test data for a single aircraft and a single nondestructive test.

5. The method of claim 1 wherein the step of displaying measurement test data further comprises displaying measurement test data for a single aircraft and multiple nondestructive tests.

6. The method of claim 1 wherein the step of storing the measurement test data further comprises storing metadata associated with the measurement test data, the metadata providing additional information for data evaluation purposes.

7. The method of claim 1 wherein the step of generating a model of the aircraft further comprises generating a model of the aircraft from a solid object model rendering of the aircraft.

8. The method of claim 1 wherein the step of nondestructively testing further comprises generating measurement test data using an ultrasonic testing device.

9. The method of claim 2 further comprising analyzing the measurement test data before the step of displaying the data.

10. The method of claim 5 further comprising analyzing the measurement test data before the step of displaying the measurement test data.

11. An apparatus for analyzing nondestructive testing data comprising:
a server computer configured to:
map an aircraft to a model of the aircraft;
determine an inspection point for the aircraft based on predetermined inspection points of the model of the aircraft; and
receive test data generated from one or more nondestructive tests of the aircraft at a test location corresponding to the inspection point;
a storage device coupled to the processor and configured to:
store the received test data with location data representative of the test location and chronological data representative of when the nondestructive testing was performed; and
a display device coupled to the processor and configured to:
display the model of the aircraft and the inspection point; and
display the received test data that corresponds to the inspection point.

12. The apparatus of claim 11 wherein the display device is further operable to display the received test data for two or more aircrafts related to the model, the received test data generated from two or more inspections of two or more aircrafts.

13. The apparatus of claim 11 wherein the display device is further operable to display the received test data for two or more aircrafts related to the model, the received test data generated from a single nondestructive test.

14. The apparatus of claim 11 wherein the display device is further operable to display the received test data for a single aircraft and a single nondestructive test.

15. The apparatus of claim 11 wherein the display device is further operable to display the received test data for a single aircraft and multiple nondestructive tests.

16. The apparatus of claim 11 wherein the server computer is further operable to receive test metadata along with the test data.

17. A system for performing nondestructive testing and viewing of data generated from the nondestructive testing comprising:
a nondestructive tester operable to perform nondestructive evaluations of a test subject and generate test data representative thereof;
a server computer coupled to the nondestructive tester, the server computer operable to:
map the test subject to a model of the test subject;
determine one or more inspection points for the test subject based on the model of the test subject; and
receive the test data generated by the nondestructive tester performing nondestructive testing at locations on the test subject corresponding to the one or more inspection points; and
a storage device coupled to the server and operable to:
store the received test data along with location data representative of the locations on the test subject where the nondestructive testing was performed.

18. The system of claim 17 further comprising:
a client computer coupled to the server and operable to request received test data from the storage device, the client computer further operable to:
display the model of the test subject with the one or more inspection points; and
display received test data generated by the nondestructive tester performing nondestructive testing at locations on the test subject corresponding to the one or more inspection points upon the selection of one of the one or more inspection points of the model of the test subject.

19. The system of claim 17 wherein the storage device is operable to store received test data for multiple test subjects and for multiple nondestructive evaluations.

20. The system of claim 17 wherein the server computer is further operable to receive metadata along with the test data.
